(19) United States
(12) Patent Application Publication
(10) Pub. No.: US 2004/0203543 A1
(43) Pub. Date: Oct. 14, 2004

(54) RFIC envelope power detection

(76) Inventor: Dror Regev, San Jose, CA (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/223,703

(22) Filed: Aug. 20, 2002

(51) Int. Cl. H04B 1/04; H01Q 11/12; H04M 1/00

(52) U.S. Cl. 455/127.1; 455/574

(57) ABSTRACT

A method and system for signal envelope detection including a detection transistor to be biased at a threshold voltage and having an input port, such that when a signal is applied to the input port, a power of an envelope of the signal is detected.

### BACKGROUND OF THE INVENTION

It is common when sending data, including voice and other, to use amplitude modulation techniques. A radio frequency (RF) carrier is often used since it is generally easy to broadcast in the RF range. When data is added to a carrier, the envelope shape is generally related to the data and the signal frequency to the carrier frequency. To read the data, for example by a receiver, it may be necessary to use a “down converter” to recreate the data embodied in the envelope.

An envelope power detector may perform the data re-creation function. These detectors generally use discrete components for biasing, matching, and filtering functions. Furthermore, traditional envelope power detectors generally comprise diodes. An implentation comprising discrete components generally requires space on a board for the discrete components, routing on a motherboard and for some applications, extra input/output (I/O) pins.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings, in which:

FIG. 1 is a block diagram illustration of a power measurement system in a transmitter, in accordance with an embodiment of the present invention;

FIG. 2 is a block diagram illustration of an in-phase/quadrature (IQ) calibration system, in accordance with an embodiment of the present invention;

FIG. 3 is a block diagram illustration of a receiver, in accordance with an embodiment of the present invention;

FIG. 4 is a block diagram illustration of a radio frequency integrated circuit (RFIC) envelope power detection system, which may be comprised in any of the embodiments shown in FIGS. 1-3, in accordance with an embodiment of the present invention;

FIG. 5 is a circuit diagram of the RFIC envelope power detection system of FIG. 4, in accordance with an embodiment of the present invention; and

FIG. 6 is a flow chart diagram of an RFIC envelope power detection method, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, and components have not been described in detail so as not to obscure the present invention.

It should be understood that the present invention may be used in a variety of applications, including, but not limited to, a mobile communication device. Although the present invention is not limited in this respect, the circuit disclosed herein may be used in many apparatuses such as in transmitters and/or receivers, for example, those of a radio system. Radio systems intended to be included within the scope of the present invention include, by way of example only, cellular radio-telephone communication systems, two-way radio communication systems, one-way pagers, two-way pagers, digital system transmitters, analog system transmitters, personal communication systems (PCS), and the like.

Thus, a radio frequency integrated circuit (RFIC) envelope power detection system according to the present invention may be comprised for example, in a transmitter or a receiver in a mobile communication device. In such an embodiment, the present invention may be used for example, to perform calibration of transmitted power or for measurement of power levels in a power amplifier or receiver.

Batteries may be used in conjunction with the system of the present invention. Many different battery types may be used and are included in the scope of this invention. For example, batteries may be removable or fixed, re-chargeable or disposable, lithium-ion or nickel-cadmium.

The present invention may be capable of extracting an envelope modulating signal from a radio frequency (RF) modulated signal in a manner similar to that of discrete component diode envelope power detectors. However, although the scope of the invention is not limited in this respect, in an embodiment of the present invention, this may be done with less than a 0.2 dB insertion loss and better than a 20 dB return loss, and may be capable of generally concurrently increasing sensitivity. As current consumption may be very low, for example 0.1 mA in the system of some embodiments of the present invention, it may be suitable for low power RFIC applications, such as wireless LAN, cellular telephones, pages, and wireless PDAs. Due to the resultant high sensitivity some embodiments of the present invention may detect signals whose power is greater than −50 dBm.

In the disclosure hereinbelow, power amplifier 6 may comprise a class-A power amplifier, although the scope of the present invention is not limited in this respect. Class B, AB, C, D, and E power amplifiers may also be used. Any such known in the art may be used.

In the disclosure hereinbelow, antenna 9 may be a dipole antenna, a shot antenna, a dual antenna, an omni-directional antenna, a loop antenna or any other antenna type which may be used with a radio frequency transmitter/receiver, if desired, although the scope of the present invention is not limited in this respect. Any such known in the art may be used.

In the disclosure hereinbelow transistors may be bi-polar junction transistors (BJT) or field effect transistors FET), although the scope of the present invention is not limited in this respect. The term input port refers equally to the base of a BJT and the gate of a FET. It is understood that use of any one of these terms implies all the rest.

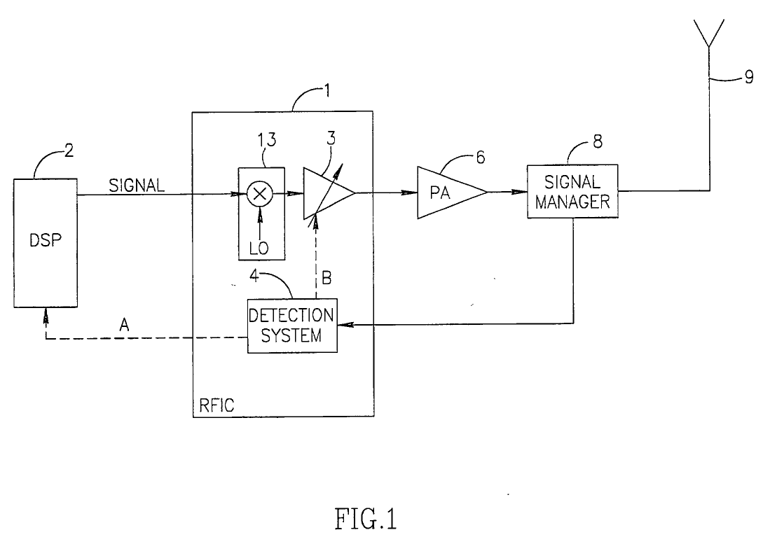

FIG. 1, to which reference is now made, is a block diagram illustration of a power measurement system in a transmitter, in accordance with an embodiment of the present invention. The power measurement system may comprise a digital signal processor (DSP) 2, an RFIC 1, a power amplifier 6, a signal manager 8, and an antenna 9. Signal manager 8 may be for example, a splitter, coupler, or a switch. RFIC 1 may comprise an optional up-converter 13, a voltage/power adjuster 3 and a radio frequency envelope power detection system in an integrated circuit (RFIC envelope power detection system) 4. Voltage/power adjuster 3 may be for example, a variable preamplifier or a variable attenuator and may be thought of as adjusting voltage or power.

DSP 2 may input a data signal to RFIC 1. The signal may be input to up-converter 13 and may then be input to voltage/power adjuster 3. The signal may be further input to power amplifier 6 and still further to signal manager 8. Depending on the function of signal manager 8, all or part of the signal may be transmitted to antenna 9 and/or back to RFIC envelope power detection system 4.

RFIC envelope power detection system 4, after determining the actual power of the signal according to an embodiment of the present invention, may perform a calibration function. Hence, RFIC envelope power detection system 4 may input calibration results to any of DSP 2 via arrow A or voltage/power adjuster 3 via arrow B. This may allow the signal to be increased or decreased in power by tuning any of DSP 2 and voltage/power adjuster 3. This may be used, for example, to ensure that the signal output to antenna 9 conforms to the standards of allowed signal power. In a further exemplary use, the signal power may be increased, for example, by voltage/power adjuster 3 to increase the range of the signal.

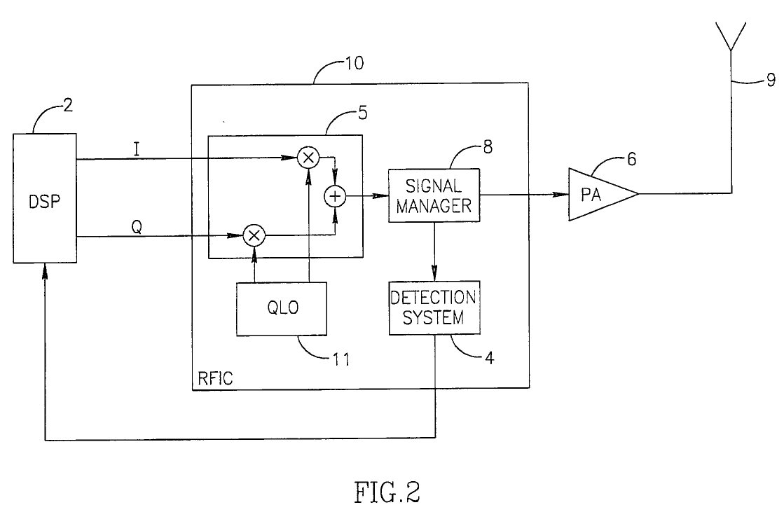

FIG. 2, to which reference is now made, is a block diagram illustration of an in-phase/quadrature (IQ) calibration system in a transmitter, in accordance with an embodiment of the present invention. The IQ calibration system may comprise DSP 2, an RFIC 10, power amplifier 6, and antenna 9. RFIC 10 may comprise a quadrature local oscillator (QLO) 11, a mixer 5, signal manager 8, and RFIC envelope power detection system 4.

DSP 2 may output both an in-phase (1) and a quadrature (Q) component, wherein the I value comprises the real portion and the Q value the imaginary portion. These components may be received by mixer 5 and mixed with an output of QLO 11. The frequencies of the two mixed signals may be added or subtracted and input to signal manager 8. Depending on the function of signal manager 8, all or part of the signal may be transmitted to power amplifier 6 and/or to RFIC envelope power detection system 4. Any partial signal received by power amplifier 6 may be transmitted over antenna 9. Any partial signal received by RFIC envelope power detection system 4 may be used to calibrate DSP 2 to correct any I and/or Q mismatches.

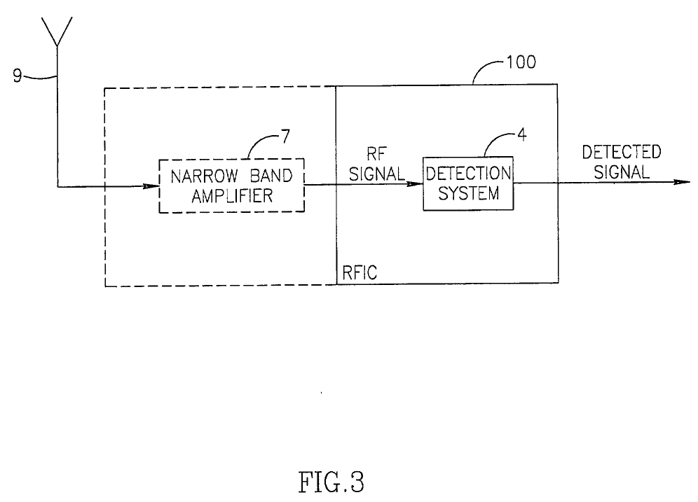

FIG. 3, to which reference is now made, is a block diagram illustration of a receiver comprising antenna 9 and an RFIC 100, in an embodiment of the present invention. An optional narrow band amplifier 7 may be part of RFIC 100 or a separate component. RFIC 100 may comprise RFIC envelope power detection system 4.

Antenna 9 may receive an RF signal. This signal may pass through a narrow band amplifier 7. The RF signal may then be input to RFIC envelope power detection system 4 where the data signal may be re-created from the RF signal. This may be done without the use of a down converter such as those known in the art, for example, Hetrodyne, Super-Hetrodyne, or Homodyne.

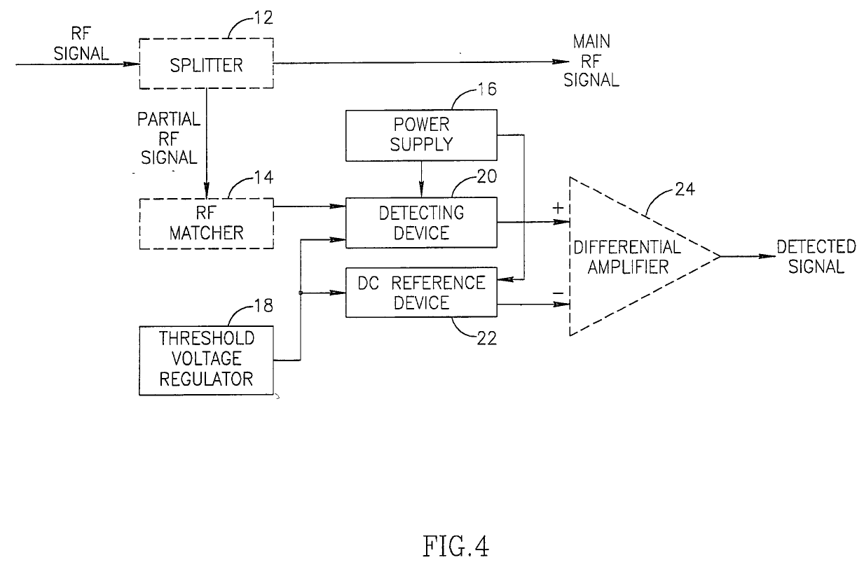

Reference is now made to FIG. 4, a block diagram illustration of a radio frequency envelope power detection system in an integrated circuit (RFIC envelope power detection system), in accordance with an embodiment of the present invention, which may comprise a splitter 12, an RF matcher 14, a threshold voltage regulator 18, a detecting device 20, and a DC reference device 22. Detecting device 20, and DC reference device 22 may be operatively connected to a power supply 16, and a differential amplifier 24. Although the present invention is not limited in this respect, use of an integrated circuit (IC) may result in savings of space, power, and money. In the discussion herein splitter 12 is functionally equivalent to signal manager 8 and the two terms may be used interchangeably.

Threshold voltage regulator 18 may utilize a current mirror. It may set the current that is input to the transistors in detecting device 20 and DC reference 22 to a value that is equal to their threshold voltage. The threshold voltage is the minimum value at which the transistor will transmit and is related to the transmission characteristics of the transistor. Thus, threshold voltage regulator 18 may be thought of as biasing both detecting device 20 and DC reference 22 to a voltage equal to the threshold value. Consequently, detecting device 20 and DC reference 22 may be “ready” to conduct and/or amplify the input voltage but may not do so, until they receive an additional RF or other voltage at the input port. There may be a savings in power on the chip since only a small amount of power may be needed at the threshold state.

Generally, envelope power detection performance is a function of the voltage out versus the power in. Hence, the greater the ratio of voltage out to power in, the better the performance. An RF signal may be input to optional splitter 12 which may split the signal unevenly into two parts. Most of the signal may continue on a given path, for example to an antenna. This may preserve the transmitted signal power, as only a small portion of the signal power may be diverted to the detection system.

If the embodiment includes splitter 12, a partial signal comprising only a portion of the transmitted signal, for example one tenth, may be received by RF matcher 14. In the case of a high impedance uneven power divider splitter, the voltage amplitude available for the detecting device may be at most one-half of the voltage of the transmit signal. If no splitter is present, the whole signal may be switched into the detection path to RF matcher 14. Hereinbelow, the term “partial signal” refers to the signal input to RF matcher 14 and may refer to a partial signal if splitter 12 is present or to the whole signal if splitter 12 is not present.

RF matcher 14 may set the maximum power that may be transferred from the splitter to the detecting device. If the RF signal is not matched, that is the impedances of the splitter and detection device are different, there may be distortions in the voltage on the line due to energy rejections that may decrease sensitivity. To increase the sensitivity of the detection unit, RF matcher 14 may further comprise inductors, which may be of a comparatively large size. The inclusion of inductors may depend on the required sensitivity of the detection.

As mentioned, detecting device 20 may receive input from power supply 16 and threshold voltage regulator 18. When the voltage at the transistors is at or below the threshold value, power supply 16 may not provide current. All or part of an RF signal may be input to detecting device 20. This signal, as mentioned hereinabove, may be received from RF matcher 14 or splitter 12 or directly. An RF signal may cause the voltage at the input port of detecting device 20 to exceed the threshold value set by threshold voltage regulator 18, and then current flowing through detecting device 20 from power supply 16 may change. Detecting device 20 may then measure the voltage it receives.

An RF signal is in alternating current (AC) whereas the RFIC may operate with direct current (DC). This may cause errors in the results of detecting device 20 if possible differences caused by the different types of currents are not accounted for and is referred to as the DC bias of the RFIC.

DC reference device 22 may receive input only from power supply 16 and threshold voltage regulator 18. As explained hereinabove, power supply 16 may only provide current when the register is above the threshold value. The voltage that DC reference device 22 may detect may not contain any contribution from the RF signal. It may detect only the voltage supplied by power supply 16 and threshold voltage regulator 18. It may thus be used as a correction factor for the DC bias of the chip. It may further be used as a correction factor for temperature and current fluctuations. The changes these fluctuations may cause in detecting device 20 may be reflected in DC reference device 22 as well, due to the proximity on the chip of detecting device 20 and DC reference device 22.

Finally, the voltages detected by detecting device 20 and DC reference device 22 may be input to differential amplifier 24. The voltage of DC reference device 22 may be subtracted from the voltage of detecting device 20. The resulting voltage may be output as the detected signal.

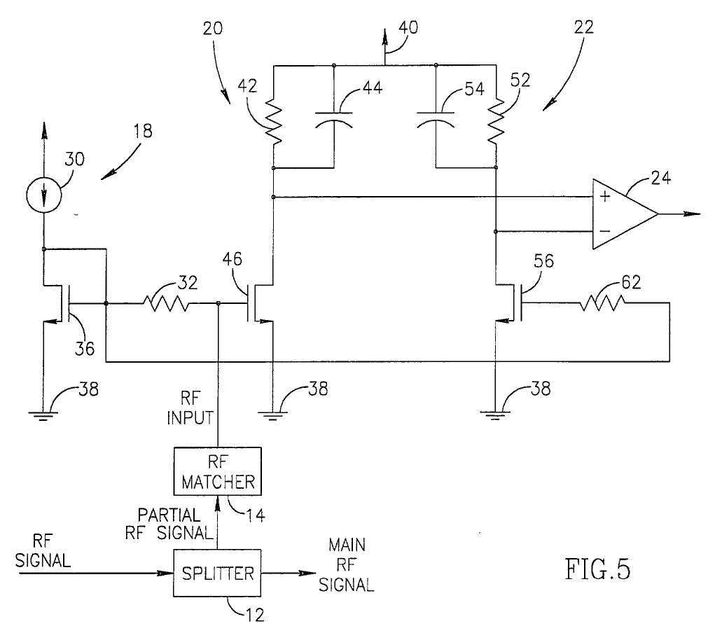

FIG. 5, to which reference is now made, is a circuit diagram of an RFIC envelope power detection system, in accordance with an embodiment of the present invention, which may comprise a current source 30 (one of ordinary skill in the art would know that a current source may also be modeled as a voltage source, and the two terms may be used interchangeably under certain circumstances) and a power supply 40, a first set of resistors 32 and 62, a second set of resistors 42 and 52, a set of capacitors 44 and 54, a set of three transistors 36, 46, and 56, and one ground 38 (shown with three labels). A threshold voltage regulator generally referenced 18 (as in FIG. 4) may comprise current source 30, transistor 36, ground 38, and resistors 32 and 62. A detecting device generally referenced-20 may comprise power supply 40, resistor 42, capacitor 44, transistor 46 and ground 38. A DC reference device generally referenced 22 may comprise power supply 40, resistor 52, capacitor 54, transistor 56 and ground 38. Also shown are the RF signal, splitter 12, RF matcher 14, and differential amplifier 24.

Current source 30 with transistor 36 may be the “current mirror” to transistors 46 and 56. This topology may set the input ports of transistors 46 and 56 to a predetermined voltage. Resistors 32 and 62 may add stability and may prevent any leakage of current to the input ports of transistors 46 and 56. This predetermined voltage may set the predetermined threshold value for detecting device 20 and DC reference device 22. Thus, current source 30 may provide a current equal to the threshold conduction value of transistors 46 and 56. Detecting device 20 and DC reference device 22 may detect a signal and amplify it simultaneously. However, this may occur only when the threshold is exceeded, for example when an RF signal is applied or a DC power fluctuation occurs.

As mentioned hereinabove, an RF signal may be divided by splitter 12 which may comprise a high impedance uneven power divider. Splitter 12 in the description herein may be used to refer to a splitter, switch, or coupler, of which any such known in the art may be used. The signal may be adjusted by RF matcher 14 as described hereinabove so that maximum power is transferred into the detecting device 20. Any RF matcher known in the art may be used, for example, RF matcher 14 may comprise an LC matcher (inductance/capacitance matcher).

When an RF signal is received, the voltage at the input port of transistor 46 may rise above the threshold value, and current may flow from power supply 40. Current may flow into resistor 42, and capacitor 44 may be charged to a new value representing the input signal. Thus, one source of voltage detected by detecting device 20 may be from an RF signal. The RF signal may be received by only transistor 46.

When the threshold value of both transistors 46 and 56 are exceeded, current from power supply 40 may flow into resistors 42 and 52, and capacitors 44 and 54 may be charged. This may occur due to changes in DC conditions in the IC. As mentioned hereinabove, this may occur, for example, due to a temperature change that may cause the threshold value to fluctuate, due to a fluctuation in the current supply, or due to some other cause, which may raise the voltage above the threshold value.

As mentioned hereinabove, detecting device 20 may decode and amplify the envelope of the RF signal and may obtain a signal generally related to the signal being carried by the RF signal. DC reference device 22 may detect a signal that may correspond to the DC signal or DC bias of the integrated circuit. Differential amplifier 24 may then receive the output of detecting device 20 as its positive input and the output of DC reference device 22 as its negative input. Differential amplifier 24 may output the difference of these inputs as the detected signal.

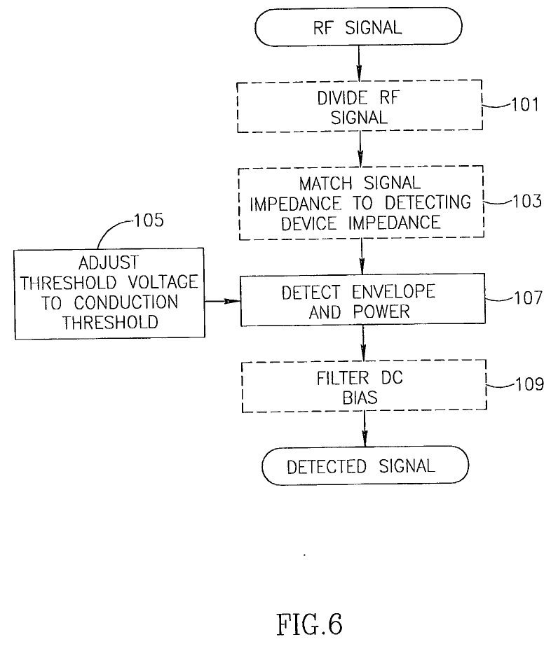

Reference is now made to FIG. 6, a flow chart diagram of an RFIC envelope power detection method, in accordance with an embodiment of the present invention. The voltage of the reference source may be adjusted to be equal to the conduction threshold of the transistors of the detecting device and the DC reference device (step 105). This may be done with a current mirror wherein reference transistor 36 may be used to set the current and input port voltages of the detecting and DC reference transistors (FIG. 5).

An RF signal may be divided (optional step 101). Hereinbelow this portion of the signal is referred to as the partial signal. In an exemplary embodiment of the present invention, the RF signal may be split unevenly, wherein only a small portion may be diverted to the RFIC envelope power detection system. A high impedance power signal manager may be used, which may comprise a high impedance resistor where the divider's impedance value may be the complex conjugate of the RF load impedance. This resistor, for example, may allow a partial signal comprising only one tenth of the total RF power. This may maximize power transmission and may save power consumption in the chip as only a small portion of the RF signal may be diverted for use by the detection system and most of the signal may be transmitted.

The impedance of the partial signal may be matched to the impedance of the detecting device (optional step 103). Having the source impedance match the detecting device impedance may reduce power reflections, which may affect the voltage on the line and may reduce sensitivity of the detecting device.

When a partial signal is received, current may begin flowing through the transistors. The detecting device may measure the power of the RF signal (and extraneous DC bias) at that instant and may detect the envelope of the partial signal (step 107). The envelope may be recreated for example, by following the peaks of the RF signals received by the detecting device. When the partial signal is received, the current through the resistors may increase and thus the voltage drop on the resistor may also increase and the capacitor may be charged. When the signal ends, the capacitor may slowly discharge through the resistor giving a good approximation of the envelope's down slope. The capacitor may discharge either until it is totally discharged or until a new partial signal is received, which may again increase the current in the resistor and may charge the capacitor. Though the envelope shape which may be recovered may not precisely match the original envelope shape it may provide a close enough approximation.

While the detecting device may be performing its measurements, the DC reference device may measure the DC bias of the detecting device. This value may be subtracted from the value measured by the detecting device (optional step 109).

The final result may be the detected signal.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A signal envelope detection system comprising:
a detection transistor to be biased at a threshold voltage and having an input port, such that when a signal is applied to the input port, a power of an envelope of the signal is detected.

2. The signal envelope detection system of claim 1 further comprising:
a current source to provide the threshold voltage to said detection transistor; and
a power supply to provide current to said detection transistor when the threshold voltage is exceeded.

3. The signal envelope detection system of claim 2 further comprising a DC reference device to receive current from said power supply when the threshold voltage of a DC reference transistor is exceeded.

4. The signal envelope detection system of claim 3 further comprising a signal manager to route a partial signal to said detection transistor.

5. The signal envelope detection system of claim 4, wherein said signal manager is a high impedance uneven power divider.

6. The signal envelope detection system of claim 4, wherein said detection transistor is a field-effect transistor.

7. The signal envelope detection system of claim 4, wherein said detection transistor is a bi-polar junction transistor.

8. The signal envelope detection system of claim 4, wherein said detection system has less than a 0.2 dB insertion loss.

9. The signal envelope detection system of claim 4, wherein said detection system has a return loss of greater than 20 dB.

10. The signal envelope detection system of claim 1, wherein said detection system has a current consumption of less than 0.1 mA.

11. The signal envelope detection system of claim 1, wherein said detection system detects signals whose power is greater than −50 dBm.

12. A method comprising:
biasing a detection transistor at a threshold voltage; and
applying a signal to an input port of the detection transistor to detect a power of an envelope of the signal.

13. The method of claim 12 further comprising:
supplying current to the detection transistor when the threshold voltage is exceeded.

14. The method of claim 13 further comprising:
supplying current to a DC reference device when the threshold voltage of a DC reference transistor is exceeded.

15. The method of claim 14 further comprising:
managing the signal routing.

16. The method of claim 15, wherein managing the signal comprises using a high impedance uneven power divider.

17. The method of claim 15, wherein the detection transistor is a field-effect transistor.

18. The method of claim 15, wherein the detection transistor is a bi-polar junction transistor.

19. The method of claim 15 further comprising:
detecting the signal with less than a 0.2 dB insertion loss.

20. The method of claim 15 further comprising:
detecting the signal with a return loss of greater than 20 dB.

21. The method of claim 12 further comprising:
detecting the signal with a current consumption of less than 0.1 mA.

22. The method of claim 12, wherein the power of the signal is greater than −50 dBm.

23. An envelope detection system comprising:
a detection transistor to be biased at a threshold voltage and having an input port, such that when a signal is applied to the input port, a power of an envelope of the signal is detected; and
a removable lithium battery to provide current to said detection transistor.

24. The envelope detection system of claim 23 wherein said battery provides power to a threshold voltage source and current to said detection transistor when the threshold voltage is exceeded.

25. The envelope detection system of claim 23 further comprising a DC reference device to receive current from the threshold voltage source when the threshold voltage of a DC reference transistor is exceeded.

26. The envelope detection system of claim 23 further comprising a signal manager to route a partial signal to said detection transistor.

27. The envelope detection system of claim 23, wherein said detection system has a current consumption of less than 0.1 mA.

28. The envelope detection system of claim 23, wherein said detection system detects signals whose power is greater than −50 dBm.
